(19) United States
(12) Patent Application Publication
(10) Pub. No.: US 2005/0155349 A1
(43) Pub. Date: Jul. 21, 2005

(54) Rotational speed and position detector for supercharger compressor

(75) Inventors: Makiko Sugiura, Hekinan-city (JP); Inao Toyoda, Anjo-city (JP); Toshitaka Yamada, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/010,366

(22) Filed: Dec. 14, 2004

(30) Foreign Application Priority Data
Jan. 15, 2004 (JP) 2004-8256

(51) Int. Cl. F02B 33/44

(52) U.S. Cl. 60/605.1

(57) ABSTRACT

A motor-assisted turbocharger is composed of a turbine driven by energy of exhaust gas, a compressor rotated by the turbine and a rotary electric machine for assisting rotation of the compressor. The turbine, the compressor blade and the rotary electric machine are connected to each other by a common rotating shaft. The compressor blade made of a material including a magnetic material faces an inner surface of a housing in which a magnetic sensor is embedded. A magnetic field in an air gap between the compressor blade and the magnetic sensor changes according to rotation of the compressor blade. The magnetic sensor detects changes in the magnetic field to thereby detect the rotational speed of the compressor blade. In place of the magnetic field, other physical amounts in the air gap, such as pressure, sound frequencies, capacitance or the like may be used for detecting the rotational speed.

### CROSS-REFERENCE TO RELATED APPLICATION

This application is based upon and claims benefit of priority of Japanese Patent Application No. 2004-8256 filed on Jan. 15, 2004, the content of which is incorporated herein by reference.

### BACKGROUND OF THE INVENTION

1. Field of the Invention

The present invention relates to a rotational speed detector, and more particularly to a device for detecting a rotational speed and a rotational position of a rotating blade of a supercharger compressor for used in an internal combustion engine.

2. Description of Related Art

A supercharger is used for compressing air to be supplied to an intake manifold of an internal combustion engine to obtain a higher output of the engine. A compressor of the supercharger is driven by various methods. For example, the compressor is rotated by a turbine driven by energy of exhaust gas. The compressor may be directly driven by a rotational torque of a crankshaft of an engine, or by an independent electric motor. The supercharger driven by the exhaust gas turbine (referred to as a turbocharger) may be assisted by an electric motor. This type of supercharger is referred to as a motor-assisted turbocharger.

In the supercharger, it is required to accurately detect a rotational speed and/or a rotational position of the compressor in order to adequately control operation of the supercharger. For example, in the turbocharger, an opening degree of a valve for introducing exhaust gas into a turbine is controlled based on a rotational speed of a compressor. In the motor-assisted turbocharger, a rotary electric machine is used as a motor for assisting the torque for driving the compressor when the engine is operating under a heavy load at a low speed. On the other hand, when the engine is operating under a light load at a high speed, the rotary electric machine is used as a generator for charging an on-board battery. It is also possible to drive another motor for assisting the engine by the electric power stored in the on-board battery. The rotary electric machine used in the motor-assisted turbocharger is switched to a motor or to a generator according to a rotational speed of the compressor.

To detect a rotational speed and a rotational position of a compressor in a motor-assisted turbocharger, JP-A-5-79340 proposes a device in which a permanent magnet is embedded in a compressor blade and magnetic poles are disposed in a stationary member facing the compressor blade. The permanent magnet is embedded in the compressor blade so that its longitudinal direction extends in the traveling direction of the blade and the longitudinal length (a distance between poles of the permanent magnet) coincides with a distance between the magnetic poles disposed in the stationary member. The rotational speed and the rotational position of the compressor blade are detected based on magnetic flux that changes according to rotation of the compressor blade.

In the detecting device disclosed in JP-A-5-79340, however, the following problems are involved. Since the permanent magnet is embedded in the rotating compressor blade, a certain weight unbalance appears in the compressor blade. Further, a process of forming the compressor blade becomes complex because the permanent magnet has to be embedded in the compressor blade, making the manufacturing cost high.

### SUMMARY OF THE INVENTION

The present invention has been made in view of the above-mentioned problems, and an object of the present invention is to provide an improved device for detecting a rotational speed and a rotational position of a compressor blade, the improved device being able to perform accurate detection and being able to be manufactured at a low cost.

A turbocharger-type supercharger is composed of a turbine driven by energy of exhaust gas from an internal combustion engine and a compressor rotated by the turbine. A torque for driving the compressor may be assisted by a rotary electric machine (referred to as a motor-assisted turbocharger). Air compressed by the compressor is supplied to an intake manifold of the engine to thereby increase an output of the engine. In the motor-assisted turbocharger, the turbine, the motor and the compressor blade are connected by a common rotating shaft.

The compressor blade is rotatably disposed in a housing, and the outer periphery of the compressor blade faces an inner surface of the housing, forming a small air gap therebetween. The housing is made of a material containing a magnetic material such as iron, nickel or cobalt. A magnetic sensor is embedded in the housing to be flat with the inner surface of the housing facing the compressor blade. A magnetic field formed in the air gap changes according to rotation of the compressor blade because the compressor blade includes projected portions. A rotational speed and/or a rotational speed of the compressor blade are detected based on the changes in the magnetic field in the air gap. Operation of the supercharger is electronically controlled based on the detected rotational speed of the compressor blade.

Since the magnetic sensor facing the compressor blade is embedded in the housing, it is not necessary to embed a permanent magnet or a magnetic material in the rotating compressor blade. Therefore, it is avoided to cause a weight unbalance in the compressor blade by embedding the permanent magnet of the like, and the compressor blade can be easily manufactured at a low cost. The changes in the magnetic field in the air gap are surely detected by the magnetic sensor embedded in the stationary housing.

The compressor blade may be made by a non-magnetic material such as aluminum, and a thin layer made of a magnetic material maybe formed on the projected portions of the compressor blade facing the magnetic sensor. The rotational speed of the compressor blade may be detected by sensing changes in physical amounts other than the magnetic field in the air gap. Pressure changes in the air gap may be detected by a pressure sensor embedded in the housing in place of the magnetic sensor. To detect sound frequencies, a microphone is embedded. Alternatively, a capacitor may be formed between the compressor blade and the housing, and the changes in the capacitance according to rotation may be detected. Further, an optical sensor may be used to detect a period of time in which light emitted from the inner surface of the housing returns to the housing after reflection on the compressor blade.

Other objects and features of the present invention will become more readily apparent from a better understanding of the preferred embodiments described below with reference to the following drawings.

### BRIEF DESCRIPTION OF THE DRAWINGS

FIG. 1 is a block diagram briefly showing an engine system having a motor-assisted turbocharger, wherein a detector, one of first to fourth embodiments of the present invention, is installed;

FIG. 2 is a cross-sectional view showing a motor-assisted turbocharger to which a detector, one of the first, the third and the fourth embodiments of the present invention, is installed;

FIG. 3 is a cross-sectional view showing a motor-assisted turbocharger to which a detector as a second embodiment of the present invention is installed;

FIG. 4 is a block diagram briefly showing an engine system having a motor-assisted turbocharger, wherein a detector as a fifth embodiment of the present invention is installed;

FIG. 5 is a cross-sectional view showing a motor-assisted turbocharger to which a detector as a fifth embodiment of the present invention is installed;

FIG. 6 is a block diagram briefly showing an engine system having a motor-assisted turbocharger, wherein a detector as a sixth embodiment of the present invention is installed; and

FIG. 7 is a cross-sectional view showing a motor-assisted turbocharger to which a detector as a sixth embodiment of the present invention is installed.

### DETAILED DESCRIPTION OF THE PREFERRED EMBODIMENTS

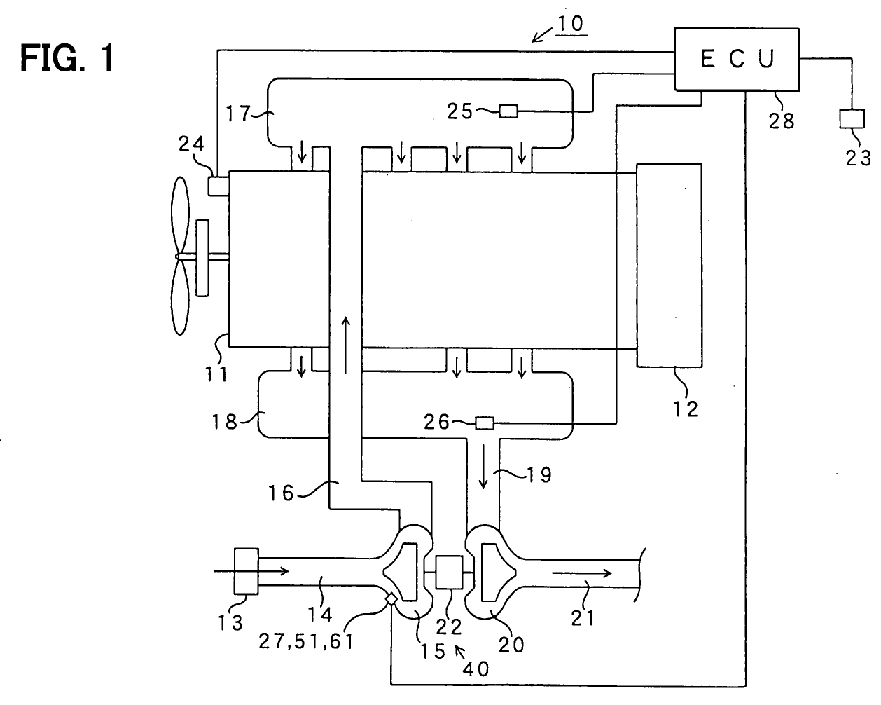

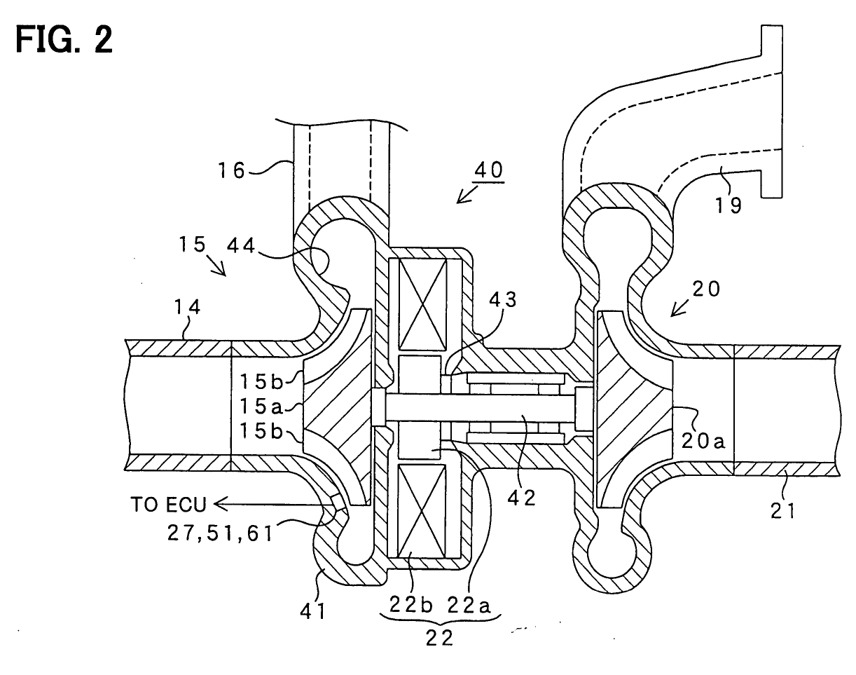

A first embodiment of the present invention will be described with reference to FIGS. 1 and 2. An engine system 10 shown in FIG. 1 has a supercharger which is referred to as a motor-assisted turbocharger. The engine system 10 includes an internal combustion engine 11, a flywheel housing 12, an air cleaner 13, an intake pipe 14, a compressor 15, a connecting pipe 16, an intake manifold 17, an exhaust manifold 18, another connecting pipe 19, a turbine 20, an exhaust pipe 21, a rotary electric machine 22, an accelerator sensor 23, an engine speed sensor 24, a pressure sensor 25, another pressure sensor 26, a magnetic sensor 27, and an electronic control unit 28 for controlling operation of the engine.

The accelerator sensor 23 detects an opening degree of an accelerator which is operated by a driver. The engine speed sensor 24 detects a rotational speed of a crankshaft (not shown) of the engine 11. The pressure sensor 25 detects a pressure in the intake manifold, i.e., an intake air pressure compressed by the compressor 15. The pressure sensor 26 detects a pressure in the exhaust manifold 18. The magnetic sensor 27 detects a rotational speed and a rotational position of the compressor 15. The electronic control unit 28 controls an amount of fuel to be supplied to the engine 11 and operation of the rotary electric machine 22 based on output signals of various sensors 23-27.

The intake air is supplied to the engine 11 through the air cleaner 13, the intake pipe 14, the compressor 15, the connecting pipe 16 and the intake manifold 17 in this order. An adequate amount of fuel, controlled by the electronic control unit 28, is mixed with the intake air, and the mixture is compressed in engine cylinders and combusted upon ignition by a spark plug. Exhaust gas generated in combustion of the mixture flows out from the engine 11 to the atmosphere through the exhaust manifold 18, the connecting pipe 19, the turbine 20 and the exhaust pipe 21. The turbine 20 is driven by the energy of the exhaust gas. The compressor 15 is connected to the turbine 20 and is driven by the turbine 20 at the same speed as the turbine 20. Air is compressed in the compressor 15 and supplied to the engine 11.

The electronic control unit 28 controls operation of the system so that the rotary electric machine 22 operates as a motor for assisting the compressor operation when the engine 11 is operated under a heavy load at a low speed and operates as a generator for storing electric power in an on-board battery when the engine 11 is operated under a light load at a high or middle speed. The operation of the rotary electric machine 22 is controlled by the electronic control unit 28, and the rotary electric machine 22 is operated as a motor or a generator according to the rotational speed and position detected by the magnetic sensor 27. Engine 11 may be assisted by another electric motor which is driven by the energy stored in the on-board battery.

FIG. 2 shows a motor-assisted turbocharger 40 used in the engine system shown in FIG. 1. The motor-assisted turbocharger 40 includes a housing 41, a rotating shaft 42, a screw 43, and a scroll 44 in addition to the compressor 15, the turbine 20 and the rotary electric machine 22 described above. The rotary electric machine 22 is an alternating current machine having a rotor 22a and a stator 22b. In the housing 41, a compressor blade 15a, a turbine blade 20a, the rotary electric machine 22, and a rotating shaft 42 (which is commonly connected to the turbine blade 20a, the rotary electric machine 22 and the compressor blade 15a) are contained. The scroll 44 which is connected to the intake manifold 17 through the connecting pipe 16 is formed in the housing 41.

The rotor 22a of the rotary electric machine 22 is fixedly connected to the rotating shaft 42 by a screw 43. The stator 22b of the rotary electric machine 22 is fixedly housed in the housing 41, and the rotor 22a is rotatably supported in the stator 22b. At one end of the rotating shaft 42, the turbine blade 20a is fixedly connected, and the compressor blade 15a is fixedly connected to the other end of the rotating shaft 42.

A wall of the housing 41 faces the compressor blade 15a, forming a small air gap therebetween. A magnetic sensor 27 is embedded in the wall of the housing 41 so that it becomes flat with the inner surface of the wall. The magnetic sensor 27 may be one selected from various kinds of magnetic sensors including a Hall-effect element, a magnetoresistive element (MRE), a magnetic diode (MD) and a magnetic transistor (MT).

The compressor blade 15a is made of a material containing a magnetic material, such as iron, chrome, nickel or cobalt. A magnetic field in the air gap between the magnetic sensor 27 and the compressor blade 15a changes according to rotation of the compressor blade 15a. That is because the magnetic field in the air gap becomes stronger every time a projected portion 15b of the compressor blade 15a comes closer to the magnetic sensor 27. Thus, the magnetic sensor 27 detects a rotational speed and a rotational position (or angle) of the compressor blade 15a.

The following advantages are attained in the first embodiment described above. Since no permanent magnet or a magnetic member is embedded in the compressor blade (which is done in the conventional detector), a rotational balance of the compressor blade 15a is not disturbed. Further, the compressor blade 15a is easily manufactured by using a material containing a magnetic material without embedding a permanent magnet or any other magnetic material. Since the surface of the magnetic sensor 27 is flat with the inner surface of the housing 41, the airflow in the compressor 15 is not adversely affected by the magnetic sensor 27. It may be possible to dispose the magnetic sensor 27 at the turbine side instead of the compressor side. However, that is not advantageous because the magnetic sensor may be damaged by a high temperature of the exhaust gas or foreign particles contained in the exhaust gas. Since the air gap between the projected portions 15b of the compressor blade 15a and the magnetic sensor 27 is made small to enhance efficiency of the compressor 15, the changes in the magnetic field in the air gap is accurately detected by the magnetic sensor 27.

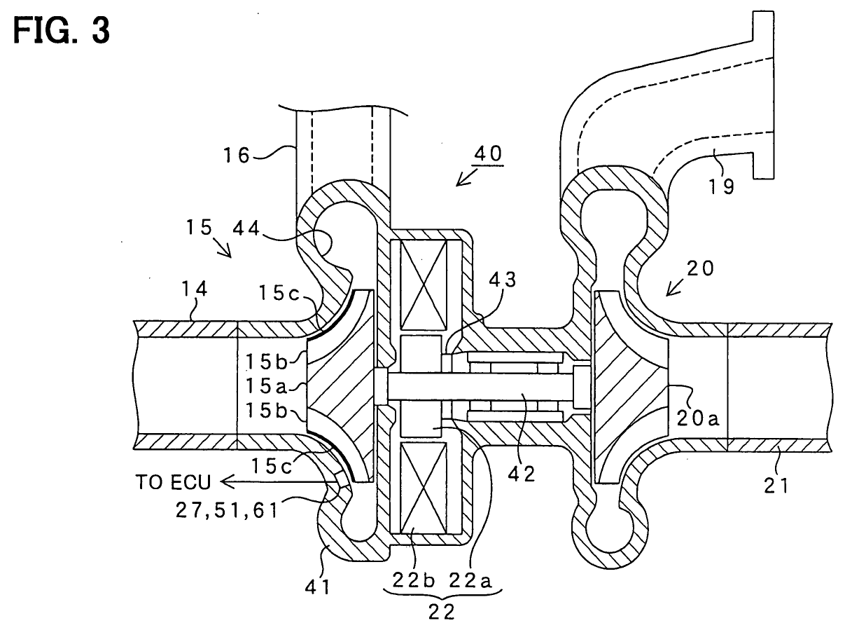

A second embodiment of the present invention will be described with reference to FIG. 3. In this embodiment, the material of the compressor blade 15a does not include a magnetic material. Instead, a layer 15c made of a magnetic material is formed on the projected portions 15b of the compressor blade 15a. The compressor blade 15a is made of a non-magnetic light material such as an aluminum alloy or a magnesium alloy. Other structures are the same as those of the first embodiment.

In cooperation of the magnetic layer 15c and the magnetic sensor 27, the rotational speed and the rotational position of the compressor blade 15a are detected in the same manner as in the first embodiment. The magnetic layer 15c may be formed by physical vapor deposition (PVD). This is considerably easier than embedding a permanent magnet or a magnetic material in the compressor blade 15a. Accordingly, the compressor blade 15a can be manufactured at a lower cost.

A third embodiment of the present invention will be described with reference to FIG. 2. In this embodiment, a pressure sensor 51 is embedded in the housing 41 in place of the magnetic sensor 27 of the first embodiment. The pressure sensor 51 is embedded to be flat with the inner surface of the housing 41. It is not necessary to contain a magnetic material in the compressor blade 15a. The pressure sensor 51 may be any appropriate type of pressure sensors, e.g., a semiconductor diaphragm type, a capacitor type, a resilient diaphragm type, a piezoelectric type, a vibration type, a Bourdon tube type, or a bellows type. Other structures are the same as those of the first embodiment.

When the projected portions 15b of the compressor blade 15a pass the position where the pressure sensor 51 is embedded, there occur changes in the pressure. The rotational speed of the compressor blade 15a is detected based on the pressure changes in the air gap. A sensitivity of the pressure sensor 51 may be improved by properly selecting a resonance frequency in the pressure sensor 51.

A fourth embodiment of the present invention will be described with reference to FIG. 2. In this embodiment, a microphone 61 is used in place of the pressure sensor 51 of the third embodiment. The microphone 61 is embedded in the housing 41 to be flat with the inner surface of the housing 41. The microphone 61 may be any type of microphones, such as a dynamic type, a capacitor type or a piezoelectric type. Other structures of the fourth embodiment are the same as those of the third embodiment. When the compressor blade 15a rotates, a sound having a frequency corresponding to the rotational speed is generated in the air gap. The rotational speed of the compressor blade 15a is detected base on the frequency sensed by the microphone 61.

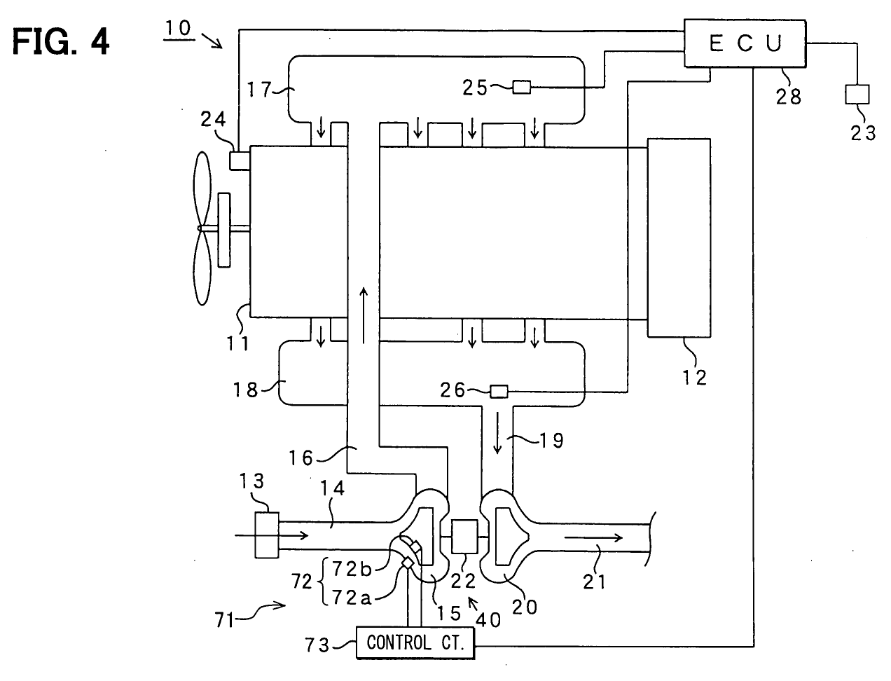

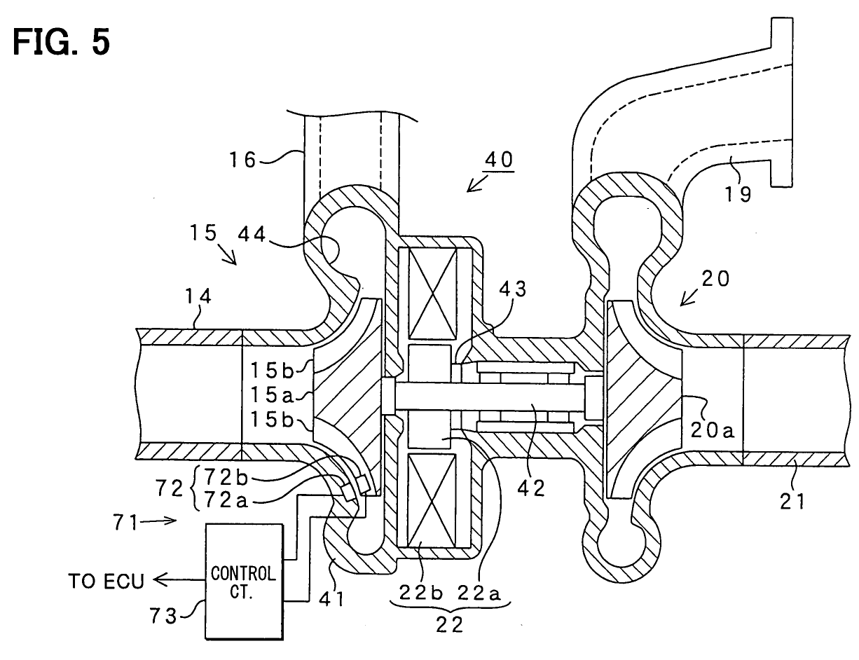

A fifth embodiment of the present invention will be described with reference to FIGS. 4 and 5. In this embodiment, a capacitance sensor 71 is used in place of the magnetic sensor 27 of the first embodiment. The capacitance sensor 71 includes a capacitor 72 and a control circuit 73. The capacitor 72 is composed of a first electrode 72a embedded in the housing 41 to be flat with the inner surface of the housing 41 and a second electrode 72b embedded in the projected portion 15b of the compressor blade 15a so that the second electrode 72b faces the first electrode 72a. There is no need to contain a magnetic material in the material forming the compressor blade 15a in this embodiment. Other structures are the same as those of the first embodiment.

A capacitance of the capacitor 72 changes according to rotation of the compressor blade 15a. That is, the capacitance increases when the second electrode 72b comes closer to the first electrode 72a, and it decreases when they become apart from each other. The rotational speed of the compressor blade 15a is detected based on the changes in the capacitance. The control circuit 73 outputs electrical signals representing the capacitance changes and feeds these signals to the electronic control unit 28. Since the second electrode 72b can be embedded in the projected portion 15b of the compressor blade 15a considerably easier than a conventional permanent magnet, the compressor blade 15 can be manufactured at a low cost.

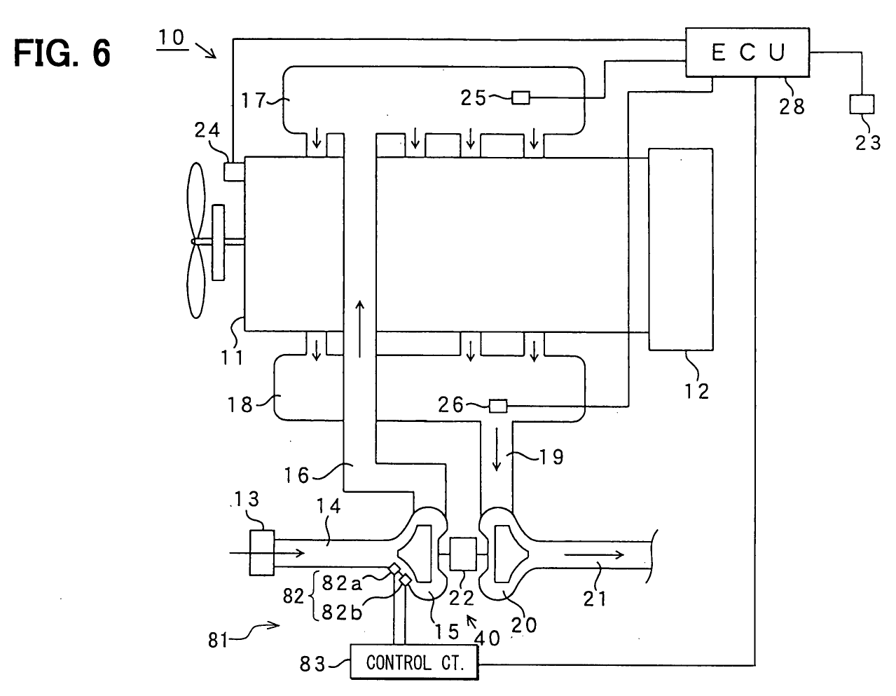

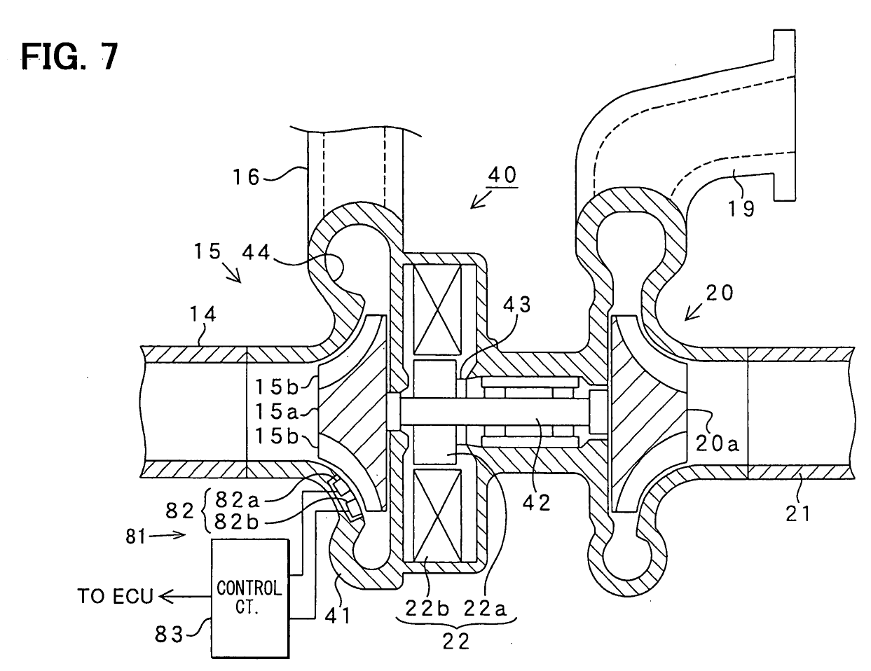

A sixth embodiment of the present invention will be described with reference to FIGS. 6 and 7. In this embodiment, an optical sensor 81 is used in place of the magnetic sensor 27 of the first embodiment. The optical sensor 81 includes optical elements 82 and a control circuit 83. The optical elements 82 are composed of a light-emitting element 82a embedded in the housing 41 to be flat with the inner surface of the housing 41 and a light-receiving element 82b similarly embedded in the housing 41. It is not necessary, in this embodiment, to make the compressor blade 15 with a material containing a magnetic material The light-emitting element 82a may be, for example, a light emitting diode, a lamp, a laser diode or an electroluminescent element. The light-receiving element 82b may be, for example, a photo-diode, a photo-transistor, or a cadmium sulfide cell. Other structures of the sixth embodiment are the same as those of the first embodiment.

The control circuit 83 generates a signal for driving the light-emitting element 82a. Light emitted from the light-emitting element 82a is reflected on the surface of the projected portion 15b of the compressor blade 15a, and the reflected light is received by the light-receiving element 82b. Since the projected portions 15b are discrete, the reflected light is received intermittently. The intermittent period of time changes in response to the rotational speed of the compressor blade 15a, i.e., the shorter the intermittent period of time, the higher the rotational speed. The control circuit 83 generates electrical signals representing the rotational speed and feeds the signals to the electronic control unit 28. Since nothing is embedded in the compressor blade in this embodiment, the compressor blade 15a can be manufactured at a low cost. It is not difficult to embed the optical elements 82 in the housing 41.

The present invention is not limited to the embodiments described above, but it may be variously modified. The present invention is applicable to other types of superchargers than the motor-assisted turbocharger 40 described above. While the present invention has been shown and described with reference to the foregoing preferred embodiments, it will be apparent to those skilled in the art that changes in form and detail may be made therein without departing from the scope of the invention as defined in the appended claims.

1. A detector for detecting a rotational speed and/or a rotational position of a supercharger compressor, the detector comprising:
a compressor blade of the super charger compressor;
a housing in which the compressor blade is rotatably housed so that an air gap between an inner surface of the housing and the compressor blade is formed; and
a sensing device, fixed to the housing to face the compressor blade, for detecting a rotational speed and/or a rotational position of the compressor blade based on changes in an physical amount in the air gap caused by rotation of the compressor blade.

2. The detector as in claim 1, wherein:
the compressor blade is made of a material containing a magnetic material; and
the sensing device is a magnetic sensor for sensing changes in magnetic field in the air gap.

3. The detector as in claim 1, wherein:
a layer made of a magnetic material is formed on the compressor blade at positions facing the air gap; and
the sensing device is a magnetic sensor for sensing changes in magnetic field in the air gap.

4. The detector as in claim 1, wherein: the sensing device is a pressure sensor for sensing changes in pressure in the air gap.

5. The detector as in claim 1, wherein:
the sensing device is a microphone for sensing changes in frequency of sounds generated in the air gap.

6. The detector as in claim 1, wherein:
the sensing device is a capacitance sensor comprising a first electrode attached to the housing and a second electrode attached to the compressor blade, the first and the second electrodes facing each other forming a capacitor, the capacitance sensor sensing changes in the capacitance of the capacitor.

7. The detector as in claim 1, wherein:
the sensing device is an optical sensor comprising a light-emitting element and a light-receiving element, both fixed to the housing to face the compressor blade, the optical sensor sensing changes in a period of time in which light-emitted from the light-emitting element is reflected on the compressor blade and is received by the light-receiving element.
